(19) United States
(12) Patent Application Publication
(10) Pub. No.: US 2015/0149601 A1
(43) Pub. Date: May 28, 2015

(54) Computer Implemented System for Collecting Usage Statistics for IT Systems

(71) Applicant: Chevron U.S.A. Inc., San Ramon, CA (US)

(72) Inventors: Laszlo Emil POPESZKU, Tomball, TX (US); David Emerson ROOT, Jr., Houston, TX (US); Harris Joseph VERDUN, Houston, TX (US)

(73) Assignees: Laszlo Emil POPESZKU, San Ramon, CA (US); Chevron U.S.A. Inc., San Ramon, CA (US); Harris Joseph VERDUN, San Ramon, CA (US); David Emerson ROOT, Jr., San Ramon, CA (US)

(21) Appl. No.: 14/089,408

(22) Filed: Nov. 25, 2013

(51) Int. Cl. H04L 12/24

(52) U.S. Cl. CPC H04L 41/0803
USPC 709/220

(57) ABSTRACT

Methods of gathering usage statistics related to computer programs implemented on one or more network computers include providing instructions comprising a configuration file generally defining settings for data exchange between specified computer programs installed on said computers and a central server, loading said instructions into a memory media and executing said instructions by a processing unit of the central server, and receiving, upon startup of a computer program, data from the computer program at the central server using the processing unit and memory media.

### BACKGROUND

Companies may have thousands of types of application software deployed internally for use by employees and other users. Usage information of the application software is important to a company for determining a proper path forward for the application software (e.g., decommissioning, rewriting, consolidating, or porting to a vendor solution). However, few systems are designed to include basic usage information relating to said application software (e.g., user ID, time/date of access, geographical location, etc.), and even fewer are simple enough or cost efficient enough to deploy.

What is needed then is a computer implemented system and method for collecting usage statistics of application software installed on network computers in a cost-effective, efficient and relatively non-intrusive manner.

### SUMMARY

In one aspect, embodiments disclosed herein relate to a network system including one or more workstations having system software installed thereon, the system software configured to operate one or more types of application software, a central server and database, a processing unit, memory media coupled to the processing unit, and instructions comprising a configuration file, wherein the configuration file generally defines settings for data exchange between the one or more types of application software and the central server, and which when loaded into the memory media and executed by the processing unit cause the central server to perform receiving data from one or more types of application software installed on one or more of the workstations.

In other aspects, embodiments disclosed herein relate to a system for providing statistics relating to usage on network workstations of one or more types of application software, the system including a central server, a processing unit and memory media coupled to the processing unit, and instructions comprising a configuration file, wherein the configuration file generally defines settings for data exchange between the one or more types of application software and the central server, and which when loaded into the memory media and executed by the processing unit cause the central server to perform receiving data upon startup of application software initiated by a user.

In yet other aspects, embodiments disclosed herein relate to a method of gathering usage statistics related to computer programs implemented on one or more network computers, the method including providing instructions comprising a configuration file generally defining settings for data exchange between specified computer programs installed on said computers and a central server, loading said instructions into a memory media and executing said instructions by a processing unit of the central server, and receiving, upon startup of a computer program, data from the computer program at the central server using the processing unit and memory media.

### BRIEF DESCRIPTION OF THE DRAWINGS

The invention is illustrated in the accompanying drawings wherein,

FIG. 1 illustrates an architecture of a computer implemented system for collecting usage statistics of application software installed on network computers in accordance with one or more embodiments;

FIG. 2 illustrates a process for gathering usage related data implemented on the computer system of FIG. 1; and

FIG. 3 illustrates a block diagram illustrating exemplary hardware components for implementing one or more embodiments of the system of FIG. 1.

### DETAILED DESCRIPTION

A computer implemented system for collecting usage statistics of application software installed on network computers is disclosed herein. Embodiments include methods, systems and software, e.g., embodied as computer-readable instructions stored on computer readable mediums, that may be referred to as an application usage data collection system. Embodiments of the system disclosed herein may be designed to request, collect or gather, and deliver data relating to usage of one or more types of application software installed on one or more user computers in a network or intranet.

One or more embodiments may provide data or information that drives application software life cycle decisions, such as decommissioning, rationalization, and consolidation of IT systems. For example, a technical support analyst may need to know an optimum time for a maintenance window based on usage trends. A management team may want to know if a user acceptance test is going as planned and if an application is being used post-production. An infrastructure team member may need to optimize the architecture of a system to meet bandwidth needs based on geography (e.g., if most of the users are in a certain location, servers hosting the application may be located there). Or an IT support team may evaluate applications for potential movement to low cost geographies and/or managed services. Audit teams may need information on what users use certain applications. And a team responsible for licensing needs information to support contract negotiations and how to properly allocate costs for a license. These are a few examples of benefits provided by one or more embodiments of the computer implemented system disclosed herein. The computer implemented system for collecting usage statistics may provide information including, but not limited to, how often an application is used per day, who is using the application, where the application is being used (e.g., geographical location), what business units are using the application, and other information.

One or more embodiments may disclose a network system including one or more workstations having system software installed thereon, the system software configured to operate one or more types of application software, a central server and database, a processing unit, memory media coupled to the processing unit, and instructions. The instructions include a configuration file that generally defines settings for data exchange between application software and the central server and which when loaded into the memory media and executed by the processing unit cause the central server to perform receiving data from one or more types of application software installed on one or more of the workstations.

As used herein, a configuration file configures initial settings, such as application ID or group ID, for computer programs (e.g., application software). Generally, configuration files define settings “outside” of the application, that is, without modifying any underlying code of the application. Configuration files may be used for user applications, server processes and operating system settings. Configuration files may also be used to define a set of commands to run upon startup or initialization of a program. Those skilled in the art will appreciate that many language specifications may be created specifically to describe and retain configurations. For example, this may include all markup languages.

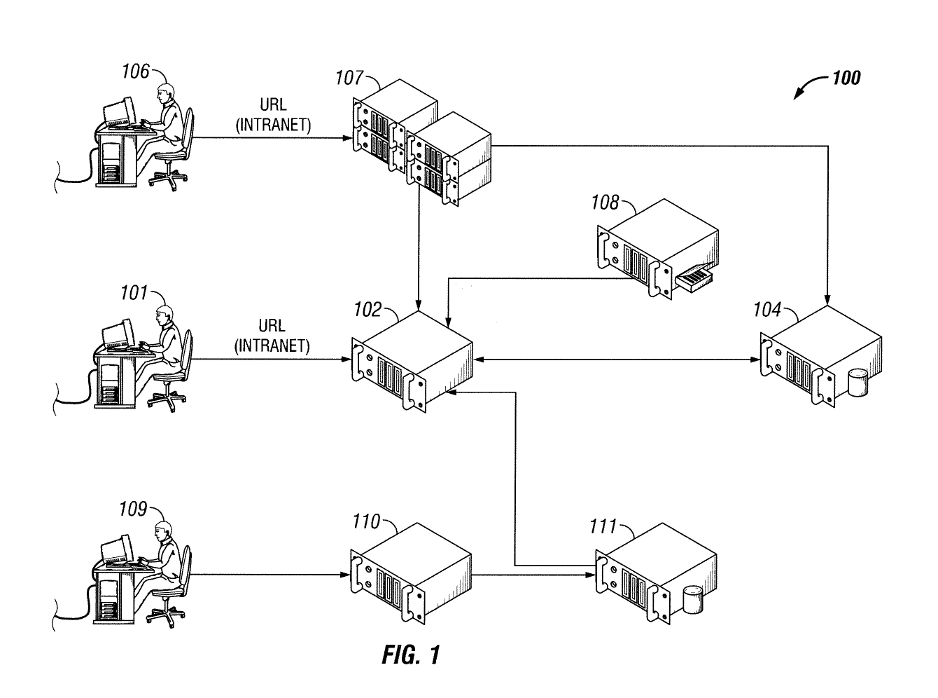

FIG. 1 illustrates an architecture of a computer implemented system 100 for collecting usage statistics of application software installed on network computers in accordance with one or more embodiments. As shown, the system 100 may include a central web server 102 and central database server 104. The central database server 104 may receive and store data received at the central web server 102. The central database server 104 may also provide or transmit stored data to the central web server 102 upon request.

The system 100 may also include one or more user workstations or computers that communicate with one or more separate servers. The user workstations may be part of any type of telecommunications network, such as a computer network or data network, that allows exchange of data among networked computing devices (e.g., network nodes) along data connections. The data connections (e.g., network links) between network nodes may be established using either cable media or wireless media. Network nodes may include hosts such as servers and personal computers and other networking hardware. The system 100 may comprise a computer network that supports applications such as access to the World Wide Web, shared use of application and storage servers, printers, and fax machines, and use of email and instant messaging applications.

Workstations 106 having web applications installed thereon may communicate with web-based application servers 107. For example, a web application may be any application that uses a web browser as a client. Directory service software installed on a server 108, which stores, organizes and provides access to information related to web applications may communicate with the central web server 102 and central database server 104. The web based application servers 107 communicate with the central web server 102. The central web server 102 communicates with the central database server 104.

Workstations 109 having client applications installed thereon may communicate with separate servers 110, such as a systems management server having software installed thereon (e.g., Microsoft System Center Configuration Manager (SCCM)). The software may be configured for managing large groups of computers running Windows, Windows Embedded, Mac OS X, Linux or UNIX, and others, as well as various mobile operating systems such as Windows Phone, Symbian, iOS and Android, and others. The server 110 may communicate with an SCCM database 111, and the SCCM database may communicate with the central web server 102.

Central server 102 may interface with one or more types of application software using configuration files to define settings for facilitating data exchange. In one embodiment, usage statistics related to web application software (e.g., a .NET web application) may be tracked. To do so, dynamic-link libraries (DLLs) are installed on an internet information services (HS) server 107, and the web application software is registered in the server 102. To “register” means to add the application software to the central database server 104. A “web.config” file of the web application software, which may be located on the Windows-based HS server (e.g., in the “application” folder), is modified to define an HTTP module of server 102, and ensure the central server 102 is initiated (e.g., gathers usage statistics) at the same time the web application software is initiated. A server 102 configuration file, located on the Windows-based HS server (in the application folder), is created, which provides an ID of the web application software used to record the data received at the central server 102 relating to usage of the web application software.

In other embodiments, usage statistics related to active server pages (classic ASP) web applications may be tracked. To do so, DLLs are installed on an HS server, and the application is registered in the server 102. A session start event handler in the web application software “global.asa” file, located on the Windows-based IIS server (e.g., in the “application” folder), is modified to communicate with the ASP DLL and ensure that the central server 102 is initiated at the same time the web application software is initiated. A server 102 configuration file, located on the Windows-based IIS server (in the application folder), is set up which provides an ID of the web application software used to record the data received at the central server 102 relating to usage of the web application software.

Tracking usage statistics for web application software for which code may be modified does not require DLL installation on server 107. To do so, the application is registered in the system 100. The web application software “web.config” file, located on the Windows-based IIS server (e.g., in the “application” folder), is modified to provide the application ID used to record data relating to the web application software's usage. The session start event handler in the “global.asax” file, located on the Windows-based IIS server (in the application folder), is modified to submit an http request to the server 102 with application specific parameter data and ensure that the server 102 is initiated at the same time the web application software is initiated.

In still other embodiments, to track usage statistics on a classic ASP web application, the application is registered in the server 102. The session start event handler in the application's “global.asa” file, located on the Windows-based IIS server (e.g., in the “application” folder), is modified to make an http request to the system 100 asp.net page. An application ID is included in the http request. The system 100 ASP.net page is set up to submit an http request to the system 100 webserver with application specific parameter data.

In yet other embodiments, usage statistics related to client-based applications may be tracked. A software metering feature of Microsoft's System Center Configuration Manager (SCCM) may be used to gather data relating to usage of client-based applications. SCCM enables scalable software deployment, compliance settings management, and comprehensive asset management of servers, desktops, laptops, and mobile devices. To track usage statistics on a client-based application, and because not all client-based applications are setup for software metering by default, an application may first be registered with SCCM for software metering. The client-based application is registered with the server 102 to associate the SCCM application ID with the server 102 application ID. A console application on a weekly basis copies the application usage from the SCCM tables to the Metrics Collector tables.

In other embodiments, for SharePoint applications, the application is registered in the server 102. A web-part for the SharePoint application is set up which submits an http request to the Metrics Collector webserver with application specific parameter data. Cookies are also set up to simulate sessions and ensure that Metrics Collector is initiated at the start of an application.

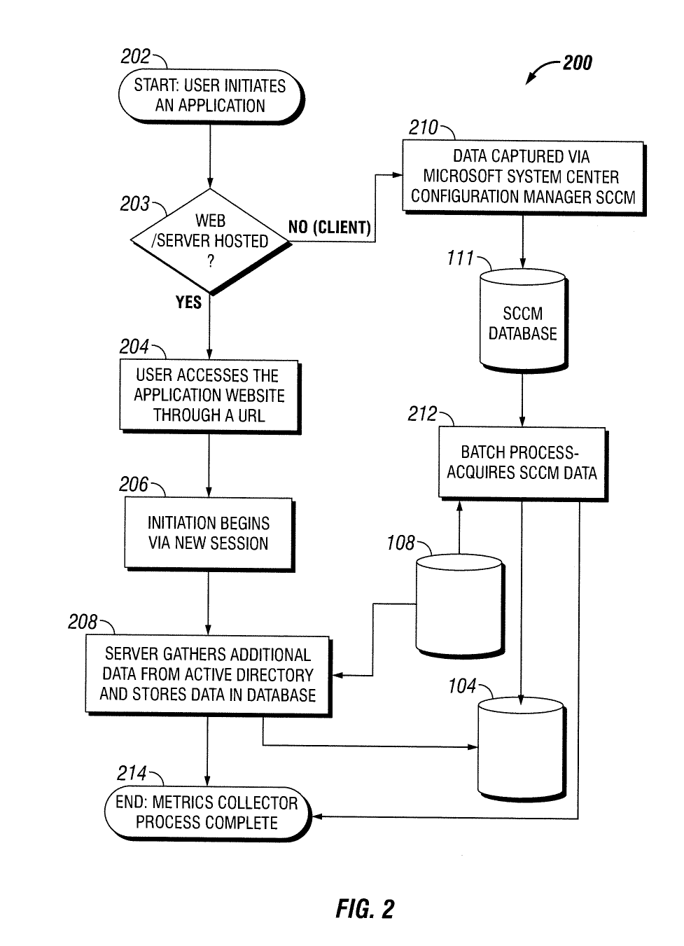

FIG. 2 illustrates a process 200 for gathering usage related data from application software installed on user computers implemented on the computer system of FIG. 1 in accordance with one or more embodiments. A user initiates application software on a work station (see process step 202). Depending upon whether or not the application software is web application or client-based application (see logic box 203), usage related data may be collected and received at the central server 102 in different manners. For web application software, the user accesses the application website through a uniform resource locater (URL) (see process step 204). The central server 102 is initiated via a new session (see process step 206). The server 102 may receive additional data from an Active Directory 108 and store the data in the central database 104 (see process step 208). Once data is gathered and stored, the process ends (see process step 214).

For client-based application software, usage related data may be captured via the SCCM (see process step 210) in the SCCM database 111. A batch process run on the central server 102 acquires SCCM data from the SCCM database (see process step 212). SCCM data acquired during the batch process is received at the central server 102 and stored in the central database 104. Once data is gathered and stored, the process ends (see process step 214).

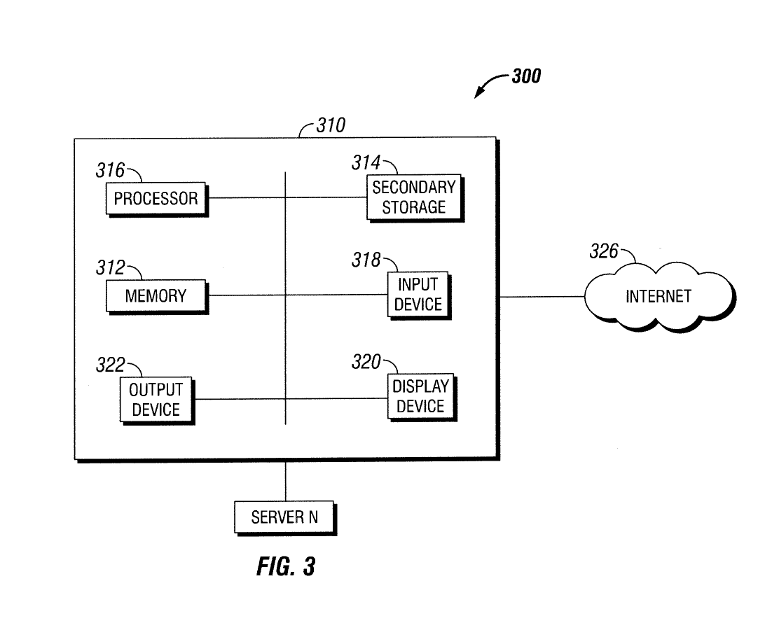

With reference now to FIG. 3, a block diagram illustrating exemplary hardware components for implementing an embodiment of system 300 for collecting usage statistics for IT systems is shown. Server 310, or other computer similarly configured, may represent central web server 102 and central database server 104, which may be operated to perform functions described herein, including steps of method 200 described above. Server 310 may connect with Internet, or other network, to receive incoming data relating to usage of application software installed on one or more user workstations.

Server 310 typically includes a memory media 312, a secondary storage device 314, and a processor or processing unit 316. Server 310 may also include a plurality of processors or processing units 316 and be configured as a plurality of, e.g., bladed servers, or other known server configurations. Server 310 may also include an input device 318, a display device 320, and an output device 322. Memory media 312 may include RAM or similar types of memory, and it may store instructions for execution by processor 316. Secondary storage device 314 may include a hard disk drive, floppy disk drive, CD-ROM drive, or other types of non-volatile data storage. Processor 316 executes the instructions, which are stored in memory media 312 or secondary storage 314, or received from the Internet or other network 326. The instructions may comprise a configuration file which when loaded into the memory media and executed by the processing unit cause the central server to perform the steps of method 200 described above. For example, the configuration file defines rules for data exchange between the one or more types of application software and the central server. The processing by processor 316 may be implemented in software, such as software modules, for execution by computers or other machines. These applications preferably include instructions executable to perform the methods described above and illustrated in the Figures herein. The applications preferably provide graphical user interfaces (GUIs) through which participants may view and interact with the central web server 102 and central web database 104 and data communicated thereto.

Server 310 may store a database structure in secondary storage 314, for example, for storing and maintaining information regarding the requested usage data relating to usage of application software described herein. For example, it may maintain a relational or object-oriented database for storing source data tables, destination data tables and configuration tables, and other information necessary to perform the above-described methods.

Also, as noted, processor 316 may execute one or more software applications in order to provide the functions described in this specification, specifically to execute and perform the steps and functions in the methods described above. Such methods and the processing may be implemented in software, such as software modules, for execution by computers or other machines. The GUIs may be formatted, for example, as web pages in HyperText Markup Language (HTML), Extensible Markup Language (XML) or in any other suitable form for presentation on a display device depending upon applications used by users to interact with the system 300.

Input device 318 may include any device for entering information into server 310, such as a keyboard, mouse, cursor-control device, touch-screen, microphone, digital camera, video recorder or camcorder. The input device 318 may be used to enter information into GUIs during performance of the methods described above. Display device 320 may include any type of device for presenting visual information such as, for example, a computer monitor or flat-screen display. The display device 320 may display the GUIs and/or output from central web server 102 or central web database 104. Output device 322 may include any type of device for presenting a hard copy of information, such as a printer, and other types of output devices include speakers or any device for providing information in audio form.

Examples of server 310 include dedicated server computers, such as bladed servers, personal computers, laptop computers, notebook computers, palm top computers, network computers, or any processor-controlled device capable of executing a web browser or other type of application for interacting with the system.

Although only one server 310 is shown in detail, system 300 may use multiple servers as necessary or desired to support the users and may also use back-up or redundant servers to prevent network downtime in the event of a failure of a particular server. In addition, although server 310 is depicted with various components, one skilled in the art will appreciate that the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling a computer system, server 310, to perform a particular method, such as methods described above.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed:

1. A network system comprising:
one or more workstations having system software installed thereon, the system software configured to operate one or more types of application software;
a central server and database;
a processing unit;
memory media coupled to the processing unit; and
instructions comprising a configuration file, wherein the configuration file generally defines settings for data exchange between the one or more types of application software and the central server, and which when loaded into the memory media and executed by the processing unit cause the central server to perform:
receiving data from one or more types of application software installed on one or more of the workstations.

2. The system of claim 1, wherein the configuration file defines initial settings without modifying code of said application software.

3. The system of claim 1, wherein the configuration file defines settings of the application software upon startup of the application software.

4. The system of claim 1, further comprising a directory service software on a server for managing data relating to web-based application software.

5. The system of claim 1, further comprising a systems management software on a server for managing data relating to client-based application software.

6. The system of claim 1, wherein data relating to usage of the application software is stored in the central database.

7. The system of claim 1, further comprising a graphical user interface coupled to the processing unit for viewing the data received at the central server.

8. The system of claim 1, further comprising one or more peripheral devices coupled to the processing unit for transferring the data to a physical media.

9. A system for providing statistics relating to usage on network workstations of one or more types of application software, the system comprising:
a central server;
a processing unit and memory media coupled to the processing unit; and
instructions comprising a configuration file, wherein the configuration file generally defines settings for data exchange between the one or more types of application software and the central server, and which when loaded into the memory media and executed by the processing unit cause the central server to perform:
receiving data upon startup of application software initiated by a user.

10. The system of claim 9, wherein the configuration file defines initial settings without modifying code of said application software.

11. The system of claim 9, wherein the configuration file defines settings of the application software upon startup of the application software.

12. The system of claim 9, further comprising a directory service software on a server for managing data relating to web-based application software.

13. The system of claim 9, further comprising a systems management software on a server for managing data relating to client-based application software.

14. The system of claim 9, wherein data relating to usage of the application software is stored in a central database in communication with the central server.

15. The system of claim 9, further comprising a graphical user interface coupled to the processing unit for viewing the data received at the central server.

16. The system of claim 9, further comprising one or more peripheral devices coupled to the processing unit for transferring the data to a physical media.

17. A method of gathering usage statistics related to computer programs implemented on one or more network computers, the method comprising:
providing instructions comprising a configuration file generally defining settings for data exchange between specified computer programs installed on said computers and a central server;
loading said instructions into a memory media and executing said instructions by a processing unit of the central server; and
receiving, upon startup of a computer program, data from the computer program at the central server using the processing unit and memory media.

18. The method of claim 17, further comprising defining initial settings for receiving data from the computer program without modifying code of the computer program.

19. The method of claim 17, further comprising running a set of commands upon startup of the application software for initiating data exchange between said software and said central server.

20. The method of claim 17, further comprising storing data received at the central server relating to said request in a central database.
